(19) United States
(12) Patent Application Publication
(10) Pub. No.: US 2012/0328211 A1
(43) Pub. Date: Dec. 27, 2012

(54) SYSTEM AND METHOD FOR SPLICING IMAGES OF WORKPIECE

(75) Inventors: CHIH-KUANG CHANG, Tu-Cheng (TW); YI-RONG HONG, Shenzhen City (CN); ZHONG-KUI YUAN, Shenzhen City (CN); LI JIANG, Shenzhen City (CN); XIAN-YI CHEN, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 13/517,668

(22) Filed: Jun. 14, 2012

(30) Foreign Application Priority Data
Jun. 24, 2011 (CN) 201110173593.8

(51) Int. Cl. G06K 9/36

(52) U.S. Cl. 382/284

(57) ABSTRACT

A computer is connected to a measurement machine. The computer receives an area selected by a user of a three-dimensional model of a workpiece which is put on the measurement machine. A first size of the selected area is calculated corresponding to resolution values of various images of the workpiece captured by a charge-coupled device (CCD). The computer calculates a number of the images which are necessary to create a complete bitmap, of a certain second size, by splicing together the various images. Coordinate values of the pixel points of the various images are calculated according to a splicing type desired and set by the user. The computer puts the pixel points into a mapping relationship according to the coordinate values of the pixel points, to create the complete bitmap.

### BACKGROUND

1. Technical Field

Embodiments of the present disclosure relate to image management systems and methods, and particularly to a system and a method for splicing images of a workpiece.

2. Description of Related Art

A video measuring system (VMS) is used for scanning images of a workpiece. If a workpiece is too large, the VMS may only scan a portion of the workpiece at one time and obtain a number of images of surfaces of the workpiece. If a user wants to analyze characteristics of surfaces of the workpiece as a whole, the images separately are not helpful for the user. Therefore, there is room for improvement in the art.

### BRIEF DESCRIPTION OF THE DRAWINGS

FIG. 1 is a block diagram of one embodiment of a computer comprising a splicing system.

FIG. 2 is a block diagram of one embodiment of the function modules of the splicing system in FIG. 1.

FIG. 3 is a flowchart illustrating one embodiment of a method for splicing together images of a workpiece.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

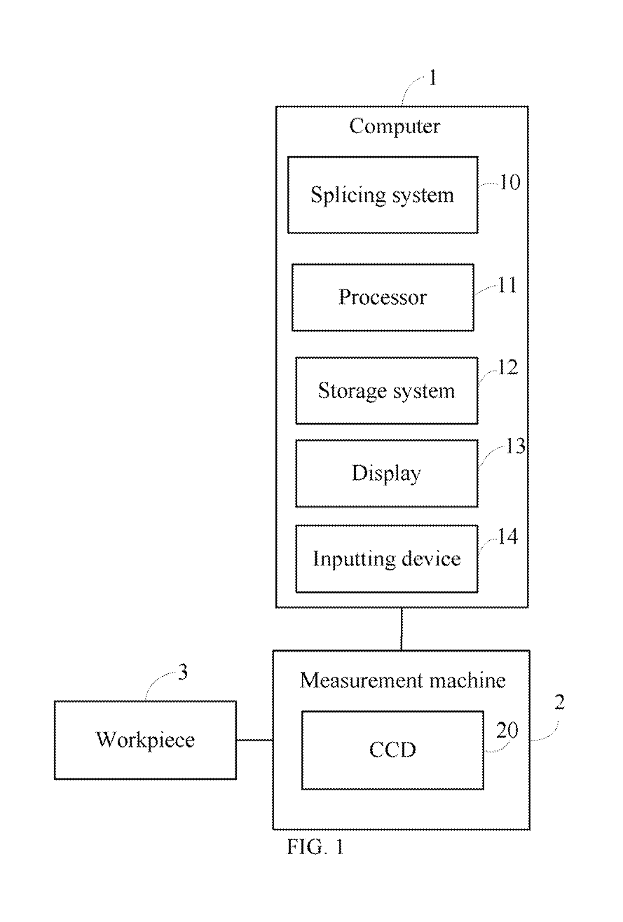

FIG. 1 is a block diagram of one embodiment of a computer 1 including a splicing system 10. The computer 1 is electronically connected to a measurement machine 2. The measurement machine 2 includes a charge-coupled device (CCD) 20. The CCD 20 scans a workpiece 3 to obtain more than one image of the workpiece 3. In some embodiments, if the workpiece 3 is too large, the CCD 20 only can scan a portion of the workpiece 3 at one time. The CCD 20 may obtain a plurality of images of the portions. The workpiece 3 is put on a work platform (not shown) of the measurement machine 2. Coordinate values of a center point of each image of the workpiece 3 are determined by the measurement machine 2. The computer 1 includes a display 13 and an inputting device 14. The inputting device 14 may be a mouse, for example. The display 13 provides a three-dimensional (3D) window for displaying a surface of a 3D model of the workpiece 3 and a bitmap window for displaying a complete bitmap spliced together from the images.

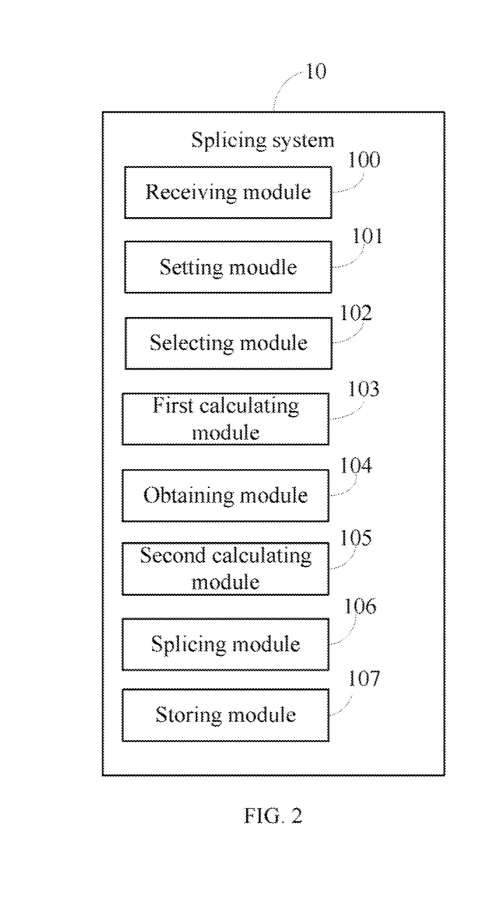

In an exemplary embodiment, the computer 1 includes at least one processor 11 and a storage system 12. The splicing system 10 may include one or more modules (also described in FIG. 2). The one or more modules may comprise computerized code in the form of one or more programs that are stored in the storage system 12. In one embodiment, the storage system 12 may be a magnetic storage system, an optical storage system, or other suitable storage medium. The computerized code includes instructions that are executed by the at least one processor 11 to provide functions for the one or more modules described below. The storage system 12 stores the 3D model of the workpiece 3, the more than one image of the workpiece 3 captured by the CCD 20, and information of each of the more than one image. The information of each of the more than one image may include a resolution value of each image, a size of each image, and red, green, blue (RGB) values of each image. The more than one image has the same resolution value and the same size. The storage system 12 also store the coordinate values of the center point of each image of the workpiece 3 in the reference coordinate. The coordinate values include coordinate values of x-axis, y-axis, and z-axis of a three dimension Cartesian coordinate system.

As shown in FIG. 2, the splicing system 10 includes a receiving module 100, a setting module 101, a selecting module 102, a first calculating module 103, an obtaining module 104, a second calculating module 105, a splicing module 106, and a storing module 107.

The receiving module 100 receives a splicing type selected by a user. The slicing type includes a two-dimensional (2D) image, a 2D measurement image, and a three-dimensional (3D) measurement image. In one embodiment, the 2D/3D measurement image includes coordinate values of a center of the 2D/3D measurement image as well as including image data. The 2D image only includes image data.

The setting module 101 receives splicing parameters set by the user corresponding to the received splicing type. The splicing parameters may include a splicing scale and a storage type. The storage type selectable may be on-board memory or hard disk.

The selecting module 102 selects an area on the 3D model of the workpiece 3 according to the user's requirement. The selected area is a portion of the surface of the 3D model of the workpiece 3. In one embodiment, the user can select a start position and an end position of the surface of the workpiece 3 to determine the selected area.

The first calculating module 103 calculates a first size of the selected area corresponding to the resolution of the images captured by the CCD 20. The first size of the selected area includes a length and a width of the selected area. If the first size is 6400*4800, the length is 6400 and the width is 4800. The length and the width indicate the number of pixel points in the area. The first calculating module 103 determines the number of images which are required and a second size of a complete bitmap of the selected area which has been spliced together from the images according to the calculated first size. For example, if the splicing type is the 2D image and the first area is 6400*4800 and the resolution of each image is 640*480, then the number of images required is determined as ten. That is, ten images need to be spliced together to generate the complete bitmap. The second size of the complete bitmap is the same as the first size.

The obtaining module 104 retrieves the determined number of images in relation to the selected area and obtains information as to each of the images from the storage system 12.

The second calculating module 105 calculates coordinate values of the pixel points of each image according to the splicing type and coordinate values of the center point of each image. For example, if the splicing type is a 2D measurement image, the second calculating module 105 calculates the coordinate values of each pixel point according to the coordinate values of an x-axis value and a y-axis value of the center point of each image of the workpiece 3.

The splicing module 106 puts each pixel point of the images into a corresponding position of the bitmap window according to the coordinate values of each pixel point of each image, as governed by the splicing parameters from the user, to splice together a complete bitmap.

The storing module 107 stores the complete bitmap to the storage system 12. In one embodiment, if the splicing type of the complete bitmap is a 2D type, the storing module 107 further provides a function of previewing the complete bitmap.

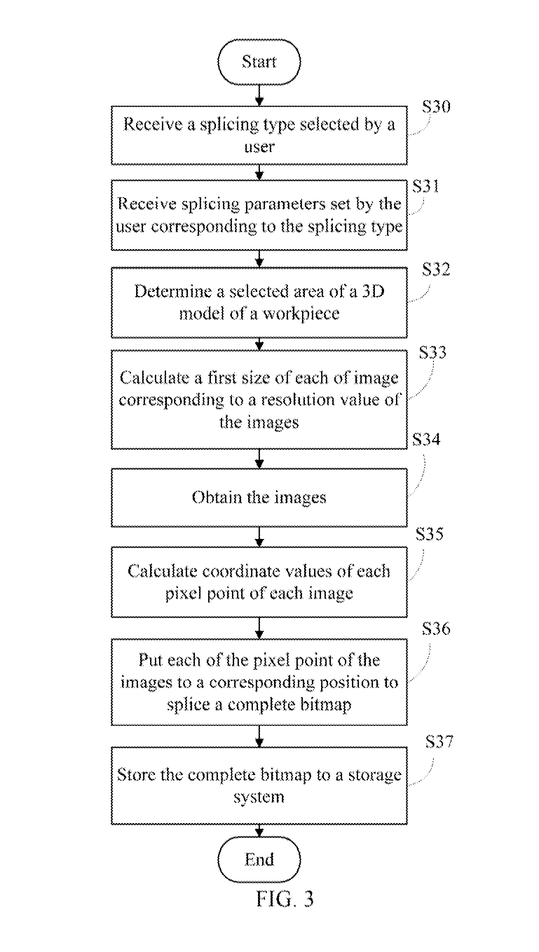

FIG. 3 is a flowchart illustrating a method for splicing images of a workpiece. Depending on the embodiment, additional steps may be added, others removed, and the ordering of the steps may be changed.

In step S30, the receiving module 100 receives the splicing type selected by a user. In some embodiments, the slicing types available may include a two-dimensional (2D) image, a 2D measurement image, and a three-dimensional (3D) measurement image.

In step S31, the setting module 101 receives splicing parameters set by the user corresponding to the received splicing type.

In step S32, the selecting module 102 determines the area on the 3D model of the workpiece 3 which has been selected by the user.

In step S33, the first calculating module 103 calculates a first size of the selected image corresponding to the resolution of the images captured by the CCD 20.

In step S34, the obtaining module 104 obtains the required number of images in relation to the selected area according to a determination, and obtains information of the images within the required number from the storage system 12.

In step S35, the second calculating module 105 calculates coordinate values of the pixel points of each scattered obtained image according to the splicing type and coordinate values of the center point of each image of the workpiece 3.

In step S36, the splicing module 106 maps the coordinate values of each pixel point of the images into a position according to the coordinate values of each pixel point of each image and the splicing parameters to splice together and produce the complete bitmap.

In step S37, the storing module 107 stores the complete bitmap to the storage system 12. In one embodiment, if the splicing type of the complete bitmap is a 2D type, the storing module 107 further provides a function of previewing the complete bitmap.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
a storage system;
at least one processor; and
one or more programs being stored in the storage system and executable by the at least one processor, the one or more programs comprising:
a receiving module that receives a splicing type selected by a user;
a selecting module that selects an area on a there-dimensional model of a workpiece displayed on a display of the computer;
a first calculating module that calculates a first size of the selected area corresponding to resolution of images, and determines a number of the images for splicing a complete bitmap and a second size of the complete bitmap according to the calculated first size;
an obtaining module that obtains the determined number of images in relation to the selected area and obtain information of the images from the storage system;
a second calculating module that calculates coordinate values of pixel points of each image according to the splicing type and coordinate values of a center point of each image; and
a splicing module puts the pixel points of the images to corresponding positions of a bitmap window displayed on the display according to the coordinate values of the pixel points of each of the images and the splicing parameters to splice the complete bitmap.

2. The computer as described in claim 1, wherein the one or more programs further comprise: a setting module that receives splicing parameters set by the user corresponding to the received splicing type.

3. The computer as described in claim 2, wherein the splicing parameters comprise a splicing scale and a storage type.

4. The computer as described in claim 1, wherein the splicing type comprises a two-dimensional (2D) image, a 2D measurement image, and a three-dimensional (3D) measurement image.

5. The computer as described in claim 1, wherein the one or more programs further comprise: a storing module that stores the complete bitmap to the storage system.

6. A computer-based method for splicing images of workpiece, comprising:
receiving a splicing type selected by a user;
selecting an area on a there-dimensional model of the workpiece displayed on a display of a computer;
calculating a first size of the selected area corresponding to resolution of images, and determining a number of the images for splicing a complete bitmap and a second size of a complete bitmap which is spliced by the images according to the calculated first size;
obtaining the determined number of images in relation to the selected area and obtain information of the images from a storage system of a computer;
calculating coordinate values of pixel points of each image according to the splicing type and coordinate values of a center point of each image; and
putting pixel points of the images to corresponding positions of a bitmap window displayed on the display according to the coordinate values of the pixel point of each of the images and the splicing parameters to splice the complete bitmap.

7. The method as described in claim 4, after the receiving step further comprising:
receiving splicing parameters set by the user corresponding to the received splicing type.

8. The method as described in claim 7, wherein the splicing parameters comprises a splicing scale and a storage type.

9. The method as described in claim 6, wherein the splicing type comprises a two-dimensional (2D) image, a 2D measurement image, and a three-dimensional (3D) measurement image.

10. The method as described in claim 6, further comprising:
storing the complete bitmap to the storage system.

11. A non-transitory storage medium having stored thereon instructions that, when executed by a processor, cause the processor to perform a method for splicing images of workpiece, the method comprising:
receiving a splicing type selected by a user;
selecting an area on a there-dimensional model of the workpiece displayed on a display of a computer;
calculating a first size of the selected area corresponding to resolution of images, and determining a number of the images for splicing a complete bitmap and a second size of a complete bitmap which is spliced by the images according to the calculated first size;
obtaining the determined number of images in relation to the selected area and obtain information of the images from a storage system of a computer;
calculating coordinate values of pixel points of each image according to the splicing type and coordinate values of a center point of each image; and
putting pixel points of the images to corresponding positions of a bitmap window displayed on the display according to the coordinate values of the pixel point of each of the images and the splicing parameters to splice the complete bitmap.

12. The non-transitory storage medium as described in claim 11, after the receiving step further comprising:
receiving splicing parameters set by the user corresponding to the received splicing type.

13. The non-transitory storage medium as described in claim 12, wherein the splicing parameters comprises a splicing scale and a storage type.

14. The non-transitory storage medium as described in claim 11, wherein the splicing type comprises a two-dimensional (2D) image, a 2D measurement image, and a three-dimensional (3D) measurement image.

15. The non-transitory storage medium as described in claim 11, further comprising:
storing the complete bitmap to the storage system.
